(19) United States
(12) Patent Application Publication
(10) Pub. No.: US 2025/0291630 A1
(43) Pub. Date: Sep. 18, 2025

(54) WORKLOAD DEPLOYMENT IN A PRIVATE CLOUD

(71) Applicant: Hewlett Packard Enterprise Development LP, Spring, TX (US)

(72) Inventors: Thavamaniraja Sakthivel, Bangalore (IN); John Lenihan, Galway (IE); Jigarkumar Narendrabhai Hingu, Bangalore (IN)

(21) Appl. No.: 18/655,393

(22) Filed: May 6, 2024

(30) Foreign Application Priority Data
Mar. 12, 2024 (IN) 202441017739

(51) Int. Cl. G06F 9/48

(52) U.S. Cl. CPC G06F 9/4881

(57) ABSTRACT

Examples described herein relate to a workload scheduler for deploying a workload in a private cloud. The workload scheduler receives a request to deploy a workload specifying a workflow to be executed. The workload scheduler then identifies a set of pre-deployed configurations based on one or more pre-deployed workloads and an identity of the workflow. Then, the workload scheduler recommends a target configuration from the set of pre-deployed configurations, and deploys the workload with the target configuration in the private cloud.

### BACKGROUND

Cloud computing infrastructures, such as public clouds and private clouds, have gained immense popularity, especially due to benefits such as high availability of resources, scalability, on-demand (e.g., as-a-service) offerings, and usage-derived operating costs. Typically, a public cloud employs shared and on-demand information technology (IT) resources (e.g., compute, storage, and/or networking systems) delivered by a third-party provider, typically, referred to as a public cloud service provider. On the other hand, the resources in the private clouds may be assigned for dedicated use by a single customer/organization. In both the public cloud and the private clouds, a customer may be able to deploy workloads (e.g., virtual computing systems, such as virtual machines, containers, pods, etc.) and use one or more types of cloud services offered by these cloud platforms.

In certain situations, due to, for example, data security concerns and the reduced overall control of data and technology of the public clouds, organizations may prefer to use private clouds to deploy workloads. A private cloud is a type of on-site cloud computing architecture that is accessed, managed, and secured by an independent enterprise or organization, providing additional virtual processing and storage resources. With a private cloud architecture, end users are not beholden to third-party providers, giving them more controlled access to their data and the ability to respond quickly in the case of component failures. The private clouds are generally provisioned with resources as per the planned usage capacity of the respective tenants. As the resources of the private cloud are located on the premises and not shared with multiple tenants, the private cloud may enable more opportunities for customized IT architectures. However, as the private cloud may have limited resources, it is wasteful to over-provision workloads as it may impact resource availability for future workload deployments. On the other hand, under-provisioning of the workloads may degrade performance.

### BRIEF DESCRIPTION OF THE DRAWINGS

Features, aspects, and advantages of the present specification will become better understood when the following detailed description is read with reference to the accompanying drawings in which like characters represent like parts throughout the drawings.

FIG. 1 depicts a system in which various of the examples presented herein may be implemented.

FIG. 2 depicts a flow diagram of an example high-level method for deploying a workload.

FIG. 3 depicts a flow diagram of another example method for deploying a workload based on a recommendation generated based on previously deployed workloads.

FIG. 4 depicts a block diagram of an example workload scheduler.

FIG. 5 depicts a block diagram of an example computing system.

It is emphasized that, in the drawings, various features are not drawn to scale. In fact, in the drawings, the dimensions of the various features have been arbitrarily increased or reduced for clarity of discussion.

### DETAILED DESCRIPTION

In the case of a public cloud, there typically exists a significantly large number of resources compared to a private cloud. Accordingly, there may be sufficient resources available to deploy almost any practically encountered workload deployment request in the public cloud. However, the private cloud is typically more tightly resource-constrained. Furthermore, adding resources to a private cloud may not be financially viable for the enterprise, especially if the need for cloud resources (e.g., compute and storage systems) is caused by additional workloads requesting cloud resources beyond a baseline level used by the enterprise. Even if the enterprise is willing and able to increase cloud resources, most enterprises do not have those resources sitting idle waiting to be readily used or powered on immediately during a surge in utilization. Accordingly, if a new workload deployment request is received and the private cloud does not have sufficient resources to host the workload specified in the new workload deployment request, the workload will often remain undeployed until sufficient resources are made available, usually due to earlier workloads completing/terminating.

Generally, workloads in a private cloud can be deployed with different workflows. Each workflow may entail executing a specific set of program files/scripts which may use a specific configuration of compute and storage resources. For instance, if the workload to be deployed includes an Oracle application, there are many possible workflow types, for example, an Oracle minimal install and an Oracle full install. Each workflow type may require a careful selection of workload configuration. In case a workload is deployed with an inappropriate configuration, customers encounter capacity and/or performance issues. For instance, if a workload is over-provisioned (e.g., allocated with more than the required number of compute and/or storage resources), the customer may waste available resources, thereby impacting future workload deployments and spending more money than necessary. For instance, an over-provisioned VM for a minimal Oracle installation leads to increased costs. Also, over-provisioning in the private cloud may lead to an increased data center footprint and decreased competitiveness due to customers spending more money on their workloads. On the other hand, if a workload is under-provisioned, the workload may suffer from inferior performance. For instance, an under-provisioned VM for a full Oracle installation may lead to performance issues. Such an under-provisioning may also lead to increased customer support request frequency due to performance issues for a cloud service provider.

A known solution attempts to address certain challenges by auto-scaling workloads to maintain application availability in the public cloud scenario. In particular, the known solution entails automatically adding or removing workload instances (generally referred to as Horizontal scaling) and adjusting the capacity of the workload instances (generally referred to as Vertical Scaling) after the workload instances are deployed and running in the public cloud to maintain steady and predictable performance of the workloads using the scaling policies that the user defines. This works well in the case of public cloud, where infrastructure resources are nearly limitless. However, in the case of the private cloud, where resources are limited, the Quality of Service (QOS) of the deployment may be impacted when additional resources are required for the deployment but there are insufficient resources available in the infrastructure.

To address the aforementioned challenges, in examples consistent with the teachings of this disclosure, a workload scheduler and a method of deploying workloads are presented. In particular, the proposed workload scheduler may suggest, at the time of provisioning a workload, a suitable configuration for the workload to be deployed in a private cloud based on relevant historical deployments. The proposed workload scheduler is an application-aware system that intelligently identifies a suitable configuration (e.g., a compute and memory specification) for a new workload deployment, based on the automation used for previous deployments.

In accordance with some examples presented herein, the proposed workload scheduler receives a request to deploy a workload in a private cloud. The request specifies a workflow to be executed to deploy the workload. Then, based on one or more pre-deployed workloads and an identity of the workflow to be executed, the workload scheduler may identify a set of pre-deployed configurations, and recommend a target configuration from the set of pre-deployed configurations. The workload scheduler may deploy the workload with the target configuration in the private cloud after receiving a user confirmation on the recommended target configuration.

As will be appreciated, by intelligently recommending the most appropriate configuration for the new workloads, the proposed solution may avoid the over-provisioning of resources, thereby reducing the cost of workload deployments. Also, the proposed solution may avoid the under-provisioning of resources, thereby avoiding workload performance issues. Furthermore, as the recommendation is provided during the provisioning phase, repeated workload reconfiguration may be avoided.

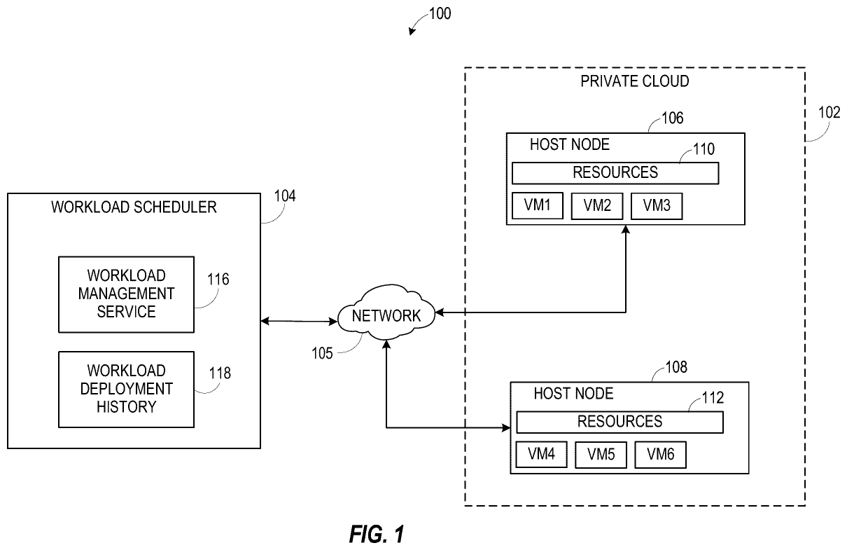

FIG. 1 illustrates an example system 100 for managing workloads in a private cloud. The system 100 is a networked system including a private cloud 102 and a workload scheduler 104. In one example implementation, the workload scheduler 104 is connected to the private cloud 102 via a network 105. In another example implementation, the workload scheduler 104 may be deployed within the private cloud 102.

The system 100 may be a distributed system where the private cloud 102 and the workload scheduler 104 are located at physically separate locations (e.g., on different racks, on different enclosures, in different buildings, in different cities, in different countries, and the like) while being connected via the network 105. In certain other examples, the system 100 may be a turnkey solution or an integrated product. In some examples, the terms “turnkey solution” or “integrated product” may refer to a ready-for-use packaged solution or product where the private cloud 102, the workload scheduler 104, and the network 105 are all disposed within a common enclosure or a common rack. Moreover, in some examples, the system 100 in any form, be it the distributed system, the turnkey solution, or the integrated product, may be capable of being reconfigured by adding or removing host nodes and/or by adding or removing internal resources (e.g., compute, storage, network cards, etc.) to and from the private cloud 102 and/or the workload scheduler 104.

The private cloud 102 may be a private network of computing, storage, and/or networking systems that may implement security and access controls to restrict access to authorized users of the private cloud 102. The authorized users may have necessary permissions and/or login credentials to access services offered via the resources hosted in the private cloud 102. In some examples, the private cloud 102 may be deployed on-site that is accessed, managed, and secured by a private cloud service provider in compliance with service level agreements with the tenant of the private cloud and/or under the control of the tenant of the private cloud. The private cloud 102 may include one or more host nodes, for example, host nodes 106 and 108. In FIG. 1, although the private cloud 102 is shown to include two host nodes 106-108, the use of any number of host nodes is also envisioned, without limiting the scope of the present disclosure.

The host nodes 106-108 are communicatively coupled to the workload scheduler 104 via a network 105. Examples of the network 105 may include, but are not limited to, an Internet Protocol (IP) or a non-IP-based local area network (LAN), a wireless LAN (WLAN), a metropolitan area network (MAN), a wide area network (WAN), a storage area network (SAN), a personal area network (PAN), a cellular communication network, a Public Switched Telephone Network (PSTN), and the Internet. In some examples, the network 105 may include one or more network switches, routers, or network gateways to facilitate data communication. Communication over the network 105 may be performed in accordance with various communication protocols such as but not limited to, Transmission Control Protocol and Internet Protocol (TCP/IP), User Datagram Protocol (UDP), IEEE 802.11, and/or cellular communication protocols. The communication over the network 105 may be enabled via wired (e.g., copper, optical communication, etc.) or wireless (e.g., Wi-Fi®, cellular communication, satellite communication, Bluetooth, etc.) communication technologies. In some examples, the network 105 may be enabled via private communication links including, but not limited to, communication links established via Bluetooth, cellular communication, optical communication, radio frequency communication, wired (e.g., copper), and the like. In some examples, the private communication links may be direct communication links between the workload scheduler 104 and the host nodes 106-108.

Each of the host nodes 106-108 may be a device including a processor, microcontroller, storage devices, and/or any other electronic component, or a device or system that may facilitate various compute and/or data storage services. Examples of the host nodes 106-108 may include a desktop computer, a laptop, a smartphone, a server, a computer appliance, a workstation, a storage device, and the like. The host nodes 106-108 may have similar or varying hardware and/or software configurations. By way of example, while some host nodes may have high-performance compute capabilities, some host nodes may facilitate strong data security, some host nodes may facilitate low-latency data read and/or write operations, certain host nodes may have enhanced thermal capabilities, some host nodes may be good at handling database operations, some host nodes may be good at handling graphics processing operations, or some host nodes may be better at storing a large amount of data. In certain other examples, all of the host nodes 106-108 may have similar hardware and/or software configurations.

The host nodes 106-108 facilitate resources, for example, compute, storage, graphics, and/or networking capabilities, for one or more workloads to execute thereon. For example, the host nodes 106 and 108 are configured with resources 110, and 112, respectively, that may include central processing units (CPUs), graphics processing units (GPUs), storage devices, and/or network ports for the functioning of the workloads hosted on the host nodes 106-108. The term workload as used herein may refer to a virtual computing or storage resource that is created by virtualizing underlying physical IT resources. Examples of workloads may include virtual machines (VMs), containers, pods, databases, virtual data stores, logical disks, or combinations thereof. In an example implementation of FIG. 1, for illustration purposes, the workloads are described as being VMs, such as the VM1, VM2, VM3, and VM4 (hereinafter collectively referred to as VMs VM1-VM6). It is to be noted that the number of VMs depicted in the private cloud 102 of FIG. 1 is for illustration purposes. The number of VMs that can be hosted on any host node may depend on the number of resources in the respective host nodes.

Further, although not shown in FIG. 1, in an example implementation with the workloads being VMs, the host nodes 106-108 may host VM management services, for example, a hypervisor (e.g., Hyper-V, VMware, or Citrix XenServer to set up the VM server.) that may allow the host nodes to run two or more operating systems. In case the workloads are containers or pods, the host nodes 106-108 may be configured with Kubernetes host node components to facilitate a runtime environment for the containers. Example Kubernetes host node components may include Kubelet (e.g., software agent to monitor containers), Kube-proxy (e.g., a network proxy to manage communications with containers), and a container runtime (e.g., software that is responsible for creating and running containers).

The workloads such as the VMs VM1-VM6 may be configured to execute one or more applications (e.g., a banking application, a social media application, an online marketplace application, a website, etc.). It is to be noted that the scope of the present disclosure is not construed to be limited to the type, use, functionalities, and/or features offered by the workloads and/or the applications hosted by the workloads in the private cloud 102. For illustration purposes, in the example of FIG. 1, the host node 106 is shown to host the VMs VM1, VM2, and VM3, and the host node 108 is shown to host the VMs VM4, VM5, and VM6. Although a certain number of VMs are shown as being hosted by each of the host nodes 106-108 as depicted in FIG. 1, the host nodes 106, 108 may host any number of VMS depending on respective hardware and/or software configurations.

In accordance with some examples presented herein, the workload scheduler 104 is configured to suggest, at the time of provisioning for a workload, an appropriate configuration for the workload for deployment in the private cloud 102 based on historical workload deployments. In particular, the proposed workload scheduler 104 is an application-aware system that intelligently identifies a suitable configuration (e.g., compute and memory specifications) for a new workload deployment, based on previous deployments in the private cloud 102. In particular, the proposed workload scheduler 104 provides a recommendation on the configuration of the new workload at the time of the provisioning phase of the new workload.

The workload scheduler 104 may be a device including a processor or microcontroller and/or any other electronic component, or a device or system that may facilitate various compute and/or data storage services, for example, and/or in particular, the management of the workloads on the host nodes 106-108. Examples of the workload scheduler 104 may include, but are not limited to, a desktop computer, a laptop, a smartphone, a server, a computer appliance, a workstation, a storage system, or a converged or hyperconverged system, and the like that is configured to manage the deployment and scheduling of workloads. Further, in certain examples, the workload scheduler 104 may be implemented as a virtual machine or a containerized application executing on hardware in the system 100. In one example, the workload scheduler 104 may be implemented as a virtual machine or a containerized application on any of the host nodes 106-108 in the system 100. The workload scheduler 104 is subscribed for use by the tenant of the private cloud 102 on a pay-per-use basis for managing workload deployments in the private cloud 102. The tenant may be able to securely access the workload scheduler 104 via a private cloud management platform which may be facilitated and managed by the private cloud service provider.

The workload scheduler 104 hosts a workload management service 116, via hardware components or by way of executing one or more instructions via a processing resource, to facilitate deployment and management of workloads on the host nodes 106-108 in the private cloud 102. The workload management service via the processing resource of the workload scheduler 104 executes a set of instructions. In some examples, the workload management service 116 may communicate with or may be built on top of the VM management software such as VMware vSphere, Veeam ONE, Hyper-V, Red Hat Virtualization, and the like. In certain examples, the workload management service 116 may communicate with or may be built on top of container orchestrator services, for example, Kubernetes control plane services.

Further, the workload scheduler 104 maintains a workload deployment history 118 storing the information about already-deployed workloads (e.g., VM1-VM6) in the private cloud 102. In particular, the workload deployment history 118 stores information including, but not limited to, workload identifiers, respective infrastructure groups, and respective workload configurations. An infrastructure group may be a user-defined categorization of a workload based on predefined criteria, for example, an intended application environment, or a workgroup/department associated with the workload or a user deploying the workload.

Further, the workloads are deployed based on a workload deployment request. In one example, a user may create and submit the workload deployment request via a graphical user interface enabled by the workload management service 116. The workload deployment request may generally specify a workflow containing a series of instructions (e.g., which generally include a set of executable scripts workload specifications). Accordingly, one example workload deployment history 118 may include certain information presented in Table-1 depicted below.

TABLE 1
Example workload deployment history

| | | Workload | Infrastructure |
|---|---|---|---|
| Workload | Workflow | Configuration | Group |
| VM1 | Oracle Minimal Install | G1-Medium | Development |
| VM2 | Oracle Full Install | G1-Large | Development |
| VM3 | Oracle Full Install | G1-XLarge | Production |
| VM4 | Oracle Minimal Install | G1-Medium | Development |
| VM5 | Oracle Minimal Install | G1-Large | Production |
| VM6 | Oracle Minimal Install | G1-Large | Development |

Further, Table-2 presented below depicts example specifics, such as a Universally Unique Identifier (UIID) of the workflow and a set of scripts contained in the workflow.

TABLE 2
Example workflow details

| Workflow | Workflow UUID | Scripts |
|---|---|---|
| Oracle | def9db20-67c2- | 1. oracle_minimal_install.sh |
| Minimal | 4b87-b04a- | 2. oracle_minimal_config.sh |
| Install | 55921f1ca583 | 3. oracle_bootup.sh |
| Oracle | 90e1daa1-f54a- | 1. oracle_full_install.sh |
| Full | 451b-83cd- | 2. oracle_full_config.sh |
| Install | e2a10d965b17 | 3. oracle_bootup.sh |

The UUID for a given workload may be a string of characters, numbers, and/or symbols that can uniquely identify the given workflow. Further, the scripts may include a set of instructions that aid in deploying a particular workload. Furthermore, a workload configuration may define the specifics of resources allocated to the workload. For example, for a given workload, the workload configuration may define the amounts of virtual CPUs (vCPUs) and Memory (e.g., RAM units or storage volumes represented as a digital storage capacity in gibibyte (GiB), for example) allocated to the given workload. The term “virtual CPU” may represent a share of a physical CPU that is assigned to the given workload (e.g., in the case of the given workload being a VM). A vCPU may use one or more physical cores of the CPU or a portion of a physical core of the CPU. Table 3 presented below defines example predefined workload configurations, some of which are used to deploy the workloads of Table-1.

TABLE 3
Example workload configurations

| Workload Configuration | vCPUs | Memory (GiB) |
|---|---|---|
| G1-Small | 1 | 4 |
| G1-Medium | 2 | 8 |
| G1-Large | 4 | 16 |
| G1-xLarge | 8 | 32 |
| G1-2xLarge | 16 | 64 |
| G1-4xLarge | 32 | 128 |
| G1-8xLarge | 64 | 256 |

Although the example workload configurations listed in Table 3 are specified in terms of the amounts of vCPUs and memory, the workload configuration defined based on other parameters is also envisioned within the scope of the present disclosure.

The workload scheduler 104 aids in recommending, at the time of user provisioning (e.g., deploying) a workload, an appropriate workload configuration for the workload that the user is trying to deploy in the private cloud 102. This helps the private cloud 102 save resources in situations when the user is inadvertently trying to deploy a workload with more than the required resources (i.e., overprovisioning the workload). Further, in certain situations when the user is deploying the workload with fewer than needed resources (i.e., underprovisioning the workload), the proposed workload scheduler 104 may suggest an appropriate configuration for the workload to perform better.

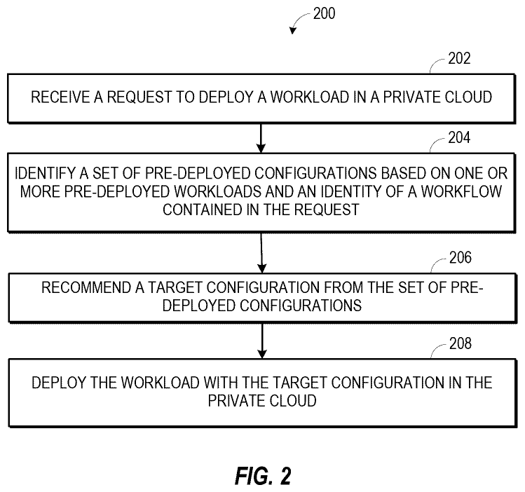

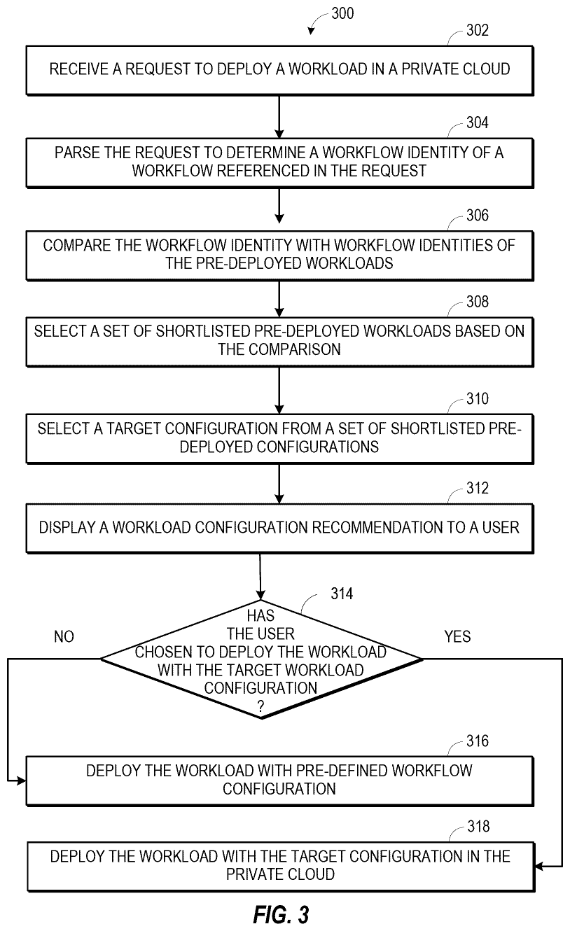

During the operation, the proposed workload scheduler 104 may receive a request to deploy a workload (hereinafter referred to as a “new workload,” for example, VM7) in the private cloud 102. The request may specify a workflow to be executed to deploy the new workload. In accordance with the examples presented herein, the workload scheduler 104 may identify a set of pre-deployed workload configurations based on one or more pre-deployed workloads (see Table 1, for example) and an identity of the workflow to be executed for the new workload. Furthermore, the workload scheduler 104 may recommend a target workload configuration from the set of pre-deployed workload configurations to the user. The workload scheduler 104 may deploy the workload with the target workload configuration in the private cloud 102 after receiving a user confirmation on the recommended target configuration. Additional details about the operations performed by the workload scheduler 104 to deploy a workload are described in conjunction with the methods described in FIGS. 2 and 3.

As will be appreciated, by intelligently recommending a better than the originally requested workload configuration for the new workload, the proposed solution may avoid the over-provisioning of resources to the new workload, thereby reducing the cost of workload deployments in the private cloud 102. Also, the proposed solution may avoid the under-provisioning of resources to the new workload, thereby avoiding performance issues for the new workload when deployed in the private cloud. Furthermore, as the workload scheduler 104 provides such recommendations during the provisioning phase, repeated workload reconfiguration may be avoided.

In the description hereinafter, various operations performed by a suitable system are described with the help of flowcharts depicted in FIGS. 2 and 3. In particular, FIGS. 2 and 3 depict flowcharts of example methods for deploying workloads in the private cloud 102. For illustration purposes, the steps shown in FIGS. 2 and 3 are described as being performed by a workload scheduler, for example, the workload scheduler 104. In some examples, the suitable device may include a processing resource suitable for the retrieval and execution of instructions stored in a machine-readable storage medium to execute the methods of FIGS. 2 and 3. Further, the flowcharts that are shown in FIGS. 2 and 3 include several steps in a particular order. However, the order of steps shown in the respective flowcharts should not be construed as the only order for the steps. The steps may be performed at any time, in any order. Additionally, the steps may be repeated, rearranged, or omitted as needed.

Referring now to 2, a flow diagram of an example method 200 for deploying a workload is presented. The method 200 includes several operations which may be performed by a workload scheduler, for example, the workload scheduler 104. For ease of illustration, the method 200 of FIG. 2 is described with reference to the system 100 of FIG. 1. However, details and/or examples presented herein should not be construed to be limited by the specifics of FIG. 1.

At block 202, the workload scheduler, for example, the workload scheduler 104 receives a request to deploy a workload (e.g., a new workload, such as, VM7) in a private cloud, for example, the private cloud 102. The workload deployment request may be initiated by a user via a workload management service (e.g., the workload management service 116) enabled via the workload scheduler. For example, the user may log in to his/her account on the workload management service and define one or more parameters (e.g., via a graphical user interface) for a new VM to be deployed and/or may select a ready-made template (e.g., VM image) with preconfigured resource requirements for the new VM. Once the user finalizes and submits the configuration of the workload, the workload deployment request may be received by the workload scheduler 104. In particular, the workload deployment request (see syntax-1, for example) may define the resource requirements for a new workload (e.g., a VM).

Syntax-1 presented below represents an example portion of a workload deployment request to deploy a new workload, for example, VM7. The workload deployment request may specify information including, but not limited to, infrastructure group, and/or resource requirements including, the number of vCPUs and the amount of memory to be allocated to the new workload—VM7.

Syntax 1 - Example portion of a workload deployment request

```
{
  ...
  “Virtual Machine name”:”VM7”
  “Image ID”: “RHEL8”
  “vCPU”: “4”
  “RAM”: “8 GiB”
  “IG”: “Development”
  “Workflow name”: “Oracle Minimal Install”
  “Workflow UUID”: “def9db20-67c2-4b87-b04a-55921f1ca583”
  ...
  }
```

Upon receiving the workload deployment request at block 202, the workload scheduler may store the workload deployment request in a workload request repository (also referred to as a deployment queue). An example content of the workload request repository is represented in Table 4, depicted below.

TABLE 4
Example workload request repository

| Workload | Image | | Infrastructure |
|---|---|---|---|
| Name | Selected | Workflow Selected | Group |
| VM7 | RHEL8 | Oracle Minimal Install | Development |

Further, at block 204, the workload scheduler identifies a set of shortlisted pre-deployed configurations based on one or more shortlisted pre-deployed workloads and an identity (e.g., the UUID or the name) of the workflow. As noted in the description of FIG. 1, the workload scheduler maintains a log of the previously deployed workloads (e.g., in the workload deployment history 118) in the private cloud. In particular, the workload scheduler performs a look-up in the workload deployment history to determine if there is any workload that was deployed using a workflow that matches the workflow indicated in the workload deployment request received at block 202. In one example, the workload scheduler may compare the workflow UIID (or workflow name) indicated in the workload deployment request with the workflow UIIDs (or workflow names) listed in the workload deployment history. Based on such comparison, the workload scheduler may identify a set of shortlisted pre-deployed workloads that were deployed using such matching workflows, and the workload configurations of such workloads are determined as the set of shortlisted pre-deployed configurations. By way of example, for the new workload deployment—VM7 requested in the workload deployment (see, Syntax 1 and Table 4), the workload scheduler may identify four workloads—VM1, VM4, VM5, and VM6 as the set of shortlisted pre-deployed workloads with matching workflow—that is, “Oracle Minimal Install.” Table 5 presented below provides information about the set of shortlisted pre-deployed workloads for the new workload—VM7.

TABLE 5
Example shortlisted workloads

| | | Workload | Infrastructure |
|---|---|---|---|
| Workload | Workflow | Configuration | Group |
| VM1 | Oracle Minimal Install | G1-Medium | Development |
| VM4 | Oracle Minimal Install | G1-Medium | Development |
| VM5 | Oracle Minimal Install | G1-Large | Production |
| VM6 | Oracle Minimal Install | G1-Large | Development |

Once the set of shortlisted pre-deployed workloads is identified, the workload scheduler, at block 206, recommends a target workload configuration from the set of shortlisted pre-deployed configurations. In some examples, the workload scheduler may further analyze the set of shortlisted pre-deployed workloads by applying one or more filtering criteria to find an appropriate workload configuration. For example, the workload scheduler may select the target configuration from the set of pre-deployed configurations based on one or more of an infrastructure group associated with the workload, a majority of the set of shortlisted pre-deployed configurations, or a user profile associated with the workload.

In an example implementation, the workload scheduler may filter out the workflows that have a different infrastructure group than indicated in the workload deployment request received at block 202. For example, the entry corresponding to the Infrastructure Group—“Production” may be filtered out as it is different from the infrastructure group—“Development” of VM7. Furthermore, in some examples, the workload scheduler may apply a majority rule to the remaining shortlisted workloads to select the target workload configuration for the new workload. For example, for the remaining shortlisted workloads (e.g., VM1, VM4, and VM6), the workload configuration “G1-Medium” is used in a majority of the workloads. Therefore, in one example, the workload scheduler may select “G1-Medium” as the target workload configuration for the new workload—VM7.

Once the target workload configuration is selected, the workload scheduler, at block 208, deploys the new workload—VM7 with the target configuration in the private cloud. In one example, the workload scheduler may display the target workload configuration as a recommended workload configuration to the user, and upon the user accepting the target workload configuration, the workload scheduler may deploy the new workload—VM7 with the target configuration.

Referring now to 3, a flow diagram of another example method 300 for deploying a workload is presented. The method 300 includes several operations which may be performed by a workload scheduler, for example, the workload scheduler 104. FIG. 3 may describe one or more additional steps to the method of FIG. 200. Further, certain features that are already described in FIG. 2 are not elaborated in detail herein. For ease of illustration, the method 300 of FIG. 3 is described with reference to the system 100 of FIG. 1, however, details and/or examples presented herein should not be construed to be limited by the specifics of FIG. 1.

At block 302, the workload scheduler, for example, the workload scheduler 104 receives a request (also referred to as a workload deployment request) to deploy a workload (e.g., a new workload, such as VM7) in a private cloud, for example, the private cloud 102. As described earlier, the workload deployment request (e.g., see, Syntax 1) for VM7 specifies the workflow (e.g., Oracle Minimal Install) to be executed to deploy VM7.

Further, at block 304, the workload scheduler parses the workload deployment request to determine the identity of the workflow (also referred to as a workflow identity) to be executed. Examples of the identity of the workflow include a workflow name and/or a workflow UUID. In particular, to determine the workflow identity, the workload scheduler may look for relevant tags in the workflow deployment request. For example, to determine the workflow UUID, the workload scheduler may look for a particular tag, for example, “Workflow UUID” in the workflow deployment request, and determine the workflow UIID as the value listed against the tag “Workflow UUID.” In this example, for VM7 to be deployed (see Syntax 1), the workload scheduler may determine the workflow UIID as “def9db20-67c2-4b87-b04a-55921f1ca583.” Further, in some examples, to determine the workflow name, the workload scheduler may look for the tag “Workflow name” in the workflow deployment request and determine the workflow name as the value listed against the tag “Workflow name.” In this example, for VM7 to be deployed (see Syntax 1), the workload scheduler may determine the workflow UIID as “Oracle Minimal Install”.

In certain examples, the workflow scheduler may determine the workflow identity based on the program files (also referred to as scripts) referenced in the respective workflow. In particular, the workflow scheduler may parse the workload deployment request to identify one or more scripts referenced in the workflow. Then, the workload scheduler may calculate a cryptographic hash of the program files referenced in the workflow. For example, the workflow scheduler may use cryptographic hash functions such as Secure Hash Algorithm (SHA)-1, SHA-2, SHA-3, SHA-256, Whirlpool, BLAKE2, BLAKE3, and/or Message Digest (MD)5 to generate the cryptographic hash value based on the program files referenced in the respective workflow. It is to be noted that the examples presented in this disclosure are not limited to the use of any particular cryptographic hash function for performing any cryptographic operation. In one example, to determine the workflow identity, the workflow scheduler may apply a cryptographic hash function to the names and/or content of the program files referenced in the workflow.

In another example, the workflow scheduler may apply a first cryptographic hash function individually to each of the filenames of the program files to generate the filename hash values, concatenate the filename hash values in a predefined order to generate a collective alphanumeric string, and then apply a second cryptographic hash function the collective alphanumeric string. The resultant value after the application of the second cryptographic hash may be determined as the workflow identity. In one example, the second cryptographic hash function may be the same as the first cryptographic hash function. In another example, the second cryptographic function may be different from the first cryptographic function.

Furthermore, at block 306, the workflow scheduler may compare the workflow identity (e.g., the workflow identity determined at block 304) with the respective workflow identities of the pre-deployed workloads. In particular, the workload scheduler performs a look-up in the workload deployment history to determine if there is any workload that was deployed using a workflow that matches the workflow indicated in the workload deployment request received at block 202. Then, at block 308, the workload scheduler may select one or more pre-deployed workloads from the pre-deployed workloads whose workflow identities match the workflow identity. The one or more pre-deployed workloads that are selected at block 308 are also referred to as a set of shortlisted pre-deployed workloads, and the workload configurations of such shortlisted pre-deployed workloads are determined as a set of shortlisted pre-deployed configurations.

Once the set of shortlisted pre-deployed workloads is identified, the workload scheduler, at block 310, selects a target workload configuration from the set of shortlisted pre-deployed configurations. In some examples, the workload scheduler may further analyze the set of shortlisted pre-deployed workloads by applying one or more criteria to find an appropriate workload configuration. In one example, the workload scheduler may select the target configuration from the set of pre-deployed configurations based on one or more of an infrastructure group associated with the workload, a majority of the set of shortlisted pre-deployed configurations, or a user profile associated with the workload, in the similar fashion as described in conjunction with FIG. 2.

After the target workload configuration is selected, the workload scheduler, at block 312, may display a workload configuration recommendation to the user. In one example, the workload configuration recommendation may be displayed via a graphical user interface enabled via a workload management service (e.g., the workload management service 116). The workload configuration recommendation may list the target workload configuration and one or more user input objects, for example, a selection button, a checkbox, etc. for the user to select or reject the target workload configuration. Further, at block 314, the workload scheduler may perform a check to determine if the user has chosen to deploy the new workload with the target workload configuration. In particular, the workload scheduler may monitor the user's response to the workload configuration recommendation by way of tracking the user input via the user input objects. If the user has given his/her acceptance to the target workload configuration, the workload scheduler may determine that the user has chosen to deploy the new workload with the target workload configuration.

At block 316, if it is determined that the user has not chosen to deploy the new workload with the target workload configuration, the workload scheduler may deploy, at block 318, the new workload with a predefined workload configuration specified in the workload deployment request. However, at block 316, if it is determined that the user has chosen to deploy the new workload with the target workload configuration, the workload scheduler may deploy, at block 318, the new workload (e.g., VM7) with the target workload configuration.

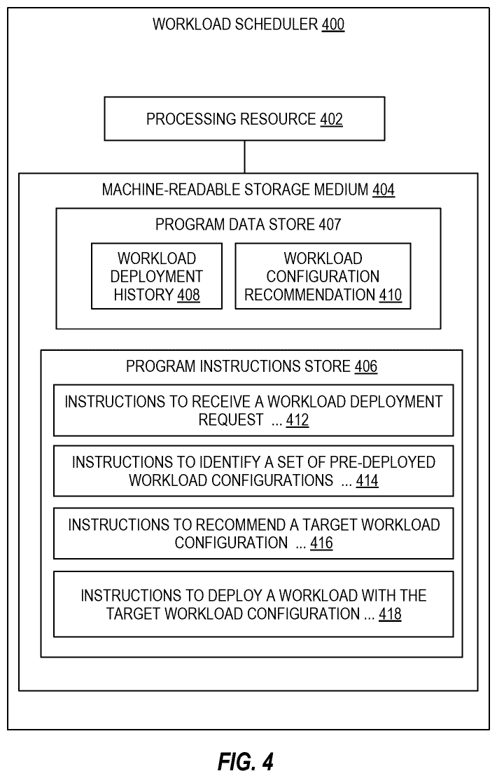

Referring now to FIG. 4, a block diagram of an example workload scheduler 400 is presented. The workload scheduler 400 of FIG. 4 may be an example representative of the workload scheduler 104 of FIG. 1. The workload scheduler 400 may be configured to manage the deployment of the workload (e.g., virtual machines) in a private cloud (for example, the private cloud 102 of FIG. 1) in a similar fashion as described in conjunction with FIGS. 1-2. In some examples, the workload scheduler 400 may include a processing resource 402 and/or a machine-readable storage medium 404 for the workload scheduler 400 to execute several operations as will be described in the greater details below.

The machine-readable storage medium 404 may be non-transitory and is alternatively referred to as a non-transitory machine-readable storage medium that does not encompass transitory propagating signals. The machine-readable storage medium 404 may be any electronic, magnetic, optical, or another type of storage device that may store data and/or executable instructions. Examples of the machine-readable storage medium 404 may include Random Access Memory (RAM), non-volatile RAM (NVRAM), an Electrically Erasable Programmable Read-Only Memory (EEPROM), a storage drive (e.g., a solid-state drive (SSD) or a hard disk drive (HDD)), a flash memory, and the like. The machine-readable storage medium 404 may include a program instructions store 406 and a program data store 407 that aid the processing resource 402 in deploying workloads in a private cloud. Although not shown, in some examples, the machine-readable storage medium 404 may be encoded with certain additional executable instructions to perform any other operations performed by the workload scheduler 400, without limiting the scope of the present disclosure.

The processing resource 402 may be a physical device, for example, a CPU, a microprocessor, a GPU, a field-programmable gate array (FPGA), application-specific integrated circuit (ASIC), other hardware devices capable of retrieving and executing instructions stored in the machine-readable storage medium 404, or combinations thereof. The processing resource 402 may fetch, decode, and execute the instructions stored in the machine-readable storage medium 404 to manage the deployment of the workloads. As an alternative or in addition to executing the instructions, the processing resource 402 may include at least one integrated circuit (IC), control logic, electronic circuits, or combinations thereof that include a number of electronic components for performing the functionalities intended to be performed by the workload scheduler 400. In some examples, when the workload scheduler 400 is implemented as a virtual resource (e.g., a VM, a container, or a software application), the processing resource 402 and the machine-readable storage medium 404 may respectively represent a processing resource and a machine-readable storage medium of a host system hosting the workload scheduler 400 as the virtual resource.

The program instructions store 406 includes instructions (depicted using dashed boxes) for deploying workloads in the private cloud (e.g., the private cloud 102). The program data store may include a workload deployment history 408 and workload configuration recommendation 410. The workload deployment history 408 may be an example representative of the workload deployment history 118 which stores details about the previously deployed workloads in the private cloud 102. Further, the workload configuration recommendation 410 may include details of a target workload configuration that the processing resource 112 may recommend based on the workload deployment history 408 and a workload deployment request. The details of identifying the target workload configuration are described in conjunction with the methods of FIGS. 2 and 3.

The program instructions store 406 includes instructions 412, 414, 416, and 418. In some examples, the processing resource 402 may enable the functionalities of a workload management service (e.g., the workload management service 116) by way of executing the instructions stored in the program instructions store 406. In particular, the instructions 412, when executed by the processing resource 402 may cause the processing resource 402 to receive a request to deploy a workload in the private cloud. As noted earlier in the description, the request specifies a workflow to be executed to deploy the workload. Further, the instructions 414 when executed by the processing resource 402 may cause the processing resource 402 to identify a set of pre-deployed configurations based on one or more pre-deployed workloads and an identity of the workflow. Furthermore, the instructions 416 when executed by the processing resource 402 may cause the processing resource 402 to recommend a target configuration from the set of pre-deployed configurations. Moreover, the instructions 418 when executed by the processing resource 402 may cause the processing resource 402 to deploy the workload with the target configuration in the private cloud. Additional details about the operations performed by the processing resource 402 by executing the instructions 412-418 are described in conjunction with the method described in FIGS. 2-3.

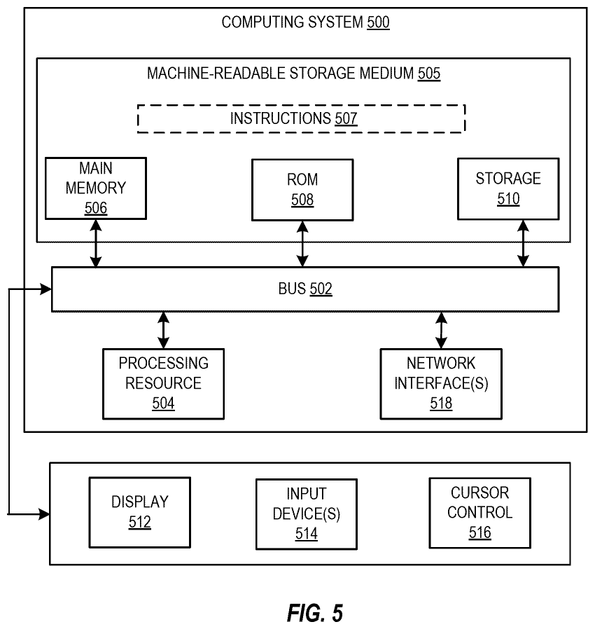

FIG. 5 depicts a block diagram of an example computing system 500 in which various of the examples described herein may be implemented. In some examples, the computing system 500 may be configured to operate as a workload scheduler, such as the workload scheduler 104 of FIG. 1, and can perform various operations described in one or more of the earlier drawings. Examples of the devices and/or systems that may be implemented as the computing system 500 may include, desktop computers, laptop computers, servers, web servers, authentication servers, Authentication, Authorization, and Accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, Personal Digital Assistants (PDAs), mobile phones, smartphones, smart terminals, dumb terminals, virtual terminals, video game consoles, virtual assistants, IoT devices, and the like.

The computing system 500 may include a bus 502 or other communication mechanisms for communicating information, a hardware processor, also referred to as processing resource 504, and a machine-readable storage medium 505 coupled to the bus 502 for processing information. In some examples, the processing resource 504 and the machine-readable storage medium 505 may be example representatives of the processing resource 402 and the machine-readable storage medium 404, respectively, depicted in FIG. 4. In some examples, the machine-readable storage medium 505 may include a main memory 506, such as a RAM, cache and/or other dynamic storage devices, coupled to the bus 502 for storing information and instructions to be executed by the processing resource 504. The main memory 506 may also be used for storing temporary variables or other intermediate information during the execution of instructions to be executed by the processing resource 504. Such instructions, when stored in storage media accessible to the processing resource 504, render the computing system 500 into a special-purpose machine that is customized to perform the operations specified in the instructions. The machine-readable storage medium 505 may further include a read-only memory (ROM) 508 or other static storage device coupled to the bus 502 for storing static information and instructions for the processing resource 504. Further, in the machine-readable storage medium 505, a storage device 510, such as a magnetic disk, optical disk, or USB thumb drive (Flash drive), etc., may be provided and coupled to the bus 502 for storing information and instructions.

In some examples, the computing system 500 may be coupled, via the bus 502, to a display 512, such as a liquid crystal display (LCD) (or touch-sensitive screen), for displaying information to a computer user. In some examples, an input device 514, including alphanumeric and other keys (physical or software generated and displayed on a touch-sensitive screen), may be coupled to the bus 502 for communicating information and command selections to the processing resource 504. Also, in some examples, another type of user input device such as a cursor control 516 may be connected to the bus 502. The cursor control 516 may be a mouse, a trackball, or cursor direction keys. The cursor control 516 may communicate direction information and command selections to the processing resource 504 for controlling cursor movement on the display 512. In some other examples, the same direction information and command selections as cursor control may be implemented via receiving touches on a touch screen without a cursor.

In some examples, the computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 500 also includes a network interface 518 coupled to bus 502. The network interface 518 provides a two-way data communication coupling to one or more network links that are connected to one or more local networks. For example, the network interface 518 may be an integrated services digital network (ISDN) card, cable modem, satellite modem, or a modem to provide a data communication connection to a corresponding type of telephone line. As another example, the network interface 518 may be a local area network (LAN) card or a wireless communication unit (e.g., Wi-Fi chip/module).

In some examples, the machine-readable storage medium 505 (e.g., one or more of the main memory 506, the ROM 508, or the storage device 510) stores instructions 507 which when executed by the processing resource 504 may cause the processing resource 504 to execute one or more of the methods/operations described hereinabove. The instructions 507 may be stored on any of the main memory 506, the ROM 508, or the storage device 510. In some examples, the instructions 507 may be distributed across one or more of the main memory 506, the ROM 508, or the storage device 510. In some examples, when the computing system 500 is configured to operate as the workload scheduler, the instructions 507 (e.g., instructions similar to the instructions 412-418 shown in FIG. 2) may include instructions that when executed by the processing resource 504 may cause the processing resource 504 to perform one or more of the methods described in FIGS. 2-3.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

The foregoing detailed description refers to the accompanying drawings. It is to be expressly understood that the drawings are for illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise. The term “based on” means based at least in part on.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

In the foregoing description, numerous details are set forth to provide an understanding of the subject matter disclosed herein. However, an implementation may be practiced without some or all of these details. Other implementations may include modifications, combinations, and variations from the details discussed above. It is intended that the following claims cover such modifications and variations.

What is claimed is:

1. A method comprising:
receiving, by a workload scheduler, a request to deploy a workload in a private cloud, wherein the request specifies a workflow to be executed to deploy the workload;
identifying, by the workload scheduler, a set of pre-deployed configurations based on one or more pre-deployed workloads and an identity of the workflow;
recommending, by the workload scheduler, a target configuration from the set of pre-deployed configurations; and
deploying, by the workload scheduler, the workload with the target configuration in the private cloud.

2. The method of claim 1, wherein the workload comprises one or more of a virtual machine, a container, or a pod.

3. The method of claim 1, further comprising parsing the request to determine the identity of the workflow, wherein the identity of the workflow comprises:
a workflow name; or
a workflow Universally Unique Identifier (UIID) of the workflow.

4. The method of claim 1, further comprising:
parsing, by the workload scheduler, the request to identify one or more program files referenced in the workflow; and
determining, by the workload scheduler, the identity of the workflow based on the one or more program files.

5. The method of claim 4, wherein determining the identity of the workflow comprises calculating a hash of the one or more program files.

6. The method of claim 1, wherein identifying the set of pre-deployed configurations comprises:
comparing, by the workload scheduler, the identity of the workflow with identities of pre-deployed workloads; and
selecting, by the workload scheduler, the one or more pre-deployed workloads from the pre-deployed workloads whose identities match with the identity of the workflow.

7. The method of claim 1, further comprising selecting, by the workload scheduler, the target configuration from the set of pre-deployed configurations based on an infrastructure group associated with the workload.

8. The method of claim 1, further comprising selecting, by the workload scheduler, the target configuration from the set of pre-deployed configurations based on a majority of the set of pre-deployed configurations.

9. The method of claim 1, further comprising selecting, by the workload scheduler, the target configuration from the set of pre-deployed configurations based on a user profile associated with the workload.

10. A workload scheduler comprising:
a machine-readable storage medium storing executable instructions;
a processing resource coupled to the machine-readable storage medium and configured to execute one or more of the instructions to:
receive a request to deploy a workload in a private cloud, wherein the workload specifies a workflow to be executed to deploy the workload;
identify a set of pre-deployed configurations based on one or more pre-deployed workloads and an identity of the workflow;
recommend a target configuration from the set of pre-deployed configurations; and
deploy the workload with the target configuration in the private cloud.

11. The workload scheduler of claim 10, wherein the processing resource is configured to execute one or more of the instructions to parsing the request to determine the identity of the workflow, wherein the identity of the workflow comprises one or more of a workflow name or a workflow Universally Unique Identifier (UIID) of the workflow.

12. The workload scheduler of claim 10, wherein the processing resource is configured to execute one or more of the instructions to:
parse the request to identify one or more program files referenced in the workflow; and
determine the identity of the workflow based on the one or more program files.

13. The workload scheduler of claim 12, wherein the processing resource is configured to execute one or more of the instructions to calculate a hash of the one or more program files to determine the identity of the workflow.

14. The workload scheduler of claim 10, wherein the processing resource is configured to execute one or more of the instructions to:
compare the identity of the workflow with identities of pre-deployed workloads; and
select the one or more pre-deployed workloads from the pre-deployed workloads whose identities match with the identity of the workflow.

15. The workload scheduler of claim 10, wherein the processing resource is configured to execute one or more of the instructions to select the target configuration from the set of pre-deployed configurations based on an infrastructure group associated with the workload.

16. The workload scheduler of claim 10, wherein the processing resource is configured to execute one or more of the instructions to select the target configuration from the set of pre-deployed configurations based on a majority of the set of pre-deployed configurations.

17. The workload scheduler of claim 10, wherein the processing resource is configured to execute one or more of the instructions to select the target configuration from the set of pre-deployed configurations based on a user profile associated with the workload.

18. A non-transitory machine-readable storage medium comprising instructions executed by a processing resource, wherein the instructions comprise:
instructions to receive a request to deploy a workload in a private cloud, wherein the workload specifies a workflow to be executed to deploy the workload;
instructions to identify a set of pre-deployed configurations based on one or more pre-deployed workloads and an identity of the workflow;
instructions to recommend a target configuration from the set of pre-deployed configurations; and
instructions to deploy the workload with the target configuration in the private cloud.

19. The non-transitory machine-readable storage medium of claim 18, wherein the instructions further comprise:
compare the identity of the workflow with identities of pre-deployed workloads; and
select the one or more pre-deployed workloads from the pre-deployed workloads whose identities match with the identity of the workflow.

20. The non-transitory machine-readable storage medium of claim 18, wherein the instructions further comprise:
select the target configuration from the set of pre-deployed configurations based on an infrastructure group associated with the workload;
select the target configuration from the set of pre-deployed configurations based on a majority of the set of pre-deployed configurations; or
select the target configuration from the set of pre-deployed configurations based on a user profile associated with the workload.
